(19) United States
(12) Patent Application Publication
(10) Pub. No.: US 2003/0001430 A1
(43) Pub. Date: Jan. 2, 2003

(54) Wheel cover structure for a vehicle of a large scale

(76) Inventor: Ming-Cheng Wang, Taichung (TW)

Correspondence Address: Alan Kamrath, Rider, Bennett, Egan & Arundel LLP., Suite 2000, 333 South Seventh Street, Minneapolis, MN, 55402, US

(21) Appl. No.: 09/887,673

(22) Filed: Jul. 2, 2001

(51) Int. Cl. B60B 27/00

(52) U.S. Cl. 301/108.4

(57) ABSTRACT

A wheel cover structure for a vehicle of a large scale includes a wheel cover, an outer cap, and a plurality of protective caps. The wheel cover includes an annular fixing rim defining multiple through holes each provided with a locking section, and a mounting barrel extending from the fixing rim and defining two opposite cavities each provided with a resting plate. The outer cap is removably secured on the mounting barrel of the wheel cover and includes two opposite snap sections each secured in the cavity, and an annular locking rib secured in the locking groove defined in the mounting barrel so that the outer cap is secured on the mounting barrel. Each of the protective caps is secured in a respective through hole of the wheel cover and has a first side defining a plurality of positioning recesses in one of which the locking section of the through hole of the wheel cover is secured, and a second side provided with a decorative protruding section extending outward from the fixing rim of the wheel cover.

### FIELD OF THE INVENTION

The present invention relates to a wheel cover structure for a vehicle is of a large scale.

### DESCRIPTION OF THE RELATED ART

A conventional wheel cover 10 for a vehicle of a large scale in accordance with the prior art shown in FIGS. 4-6 comprises a fixing section 101 mounted on the central wheel frame of the vehicle, a hollow mounting section 102 for receiving the protruding portion of the central wheel frame of the vehicle, an outer cap 20 having a rim section 201 mounted on the mounting section 102, and a bolt 30 extending through the outer cap 20 and secured in a threaded portion formed in the mounting section 102, thereby securing the outer cap 20 on the mounting section 102.

However, the user has to use a wrench to rotate the bolt 30 for unscrewing the bolt 30, thereby detaching the outer cap 20 from the mounting section 102 to expose the inside of the mounting section 102 for inspection and maintenance, thereby wasting time and needing a great deal of manual work, and thereby causing inconvenience to the use during operation of the bolt 30.

### SUMMARY OF THE INVENTION

In accordance with one aspect of the present invention, there is provided a wheel cover structure for a vehicle of a large scale comprising: a wheel cover, an outer cap, and a plurality of protective caps, wherein, the wheel cover includes:

an annular fixing rim defining a plurality of through holes each provided with an annular flange, an elastic locking section located adjacent to the annular flange, and a plurality of vent slots located adjacent to the annular flange; and

a hollow mounting barrel having a first side mounted on and extending outward from a central portion of the fixing rim and a second side defining two opposite cavities each provided with a resting plate and a plurality of reinforcing ribs located beside the resting plate, an annular locking groove defined in the second side of the mounting barrel and located beside the cavities;

the outer cap is removably secured on the mounting barrel of the wheel cover and includes:

a rim section mounted on the second side of the mounting barrel;

two opposite snap sections each mounted in the rim section, each secured in the cavity, and each rested on the resting plate; and

an annular locking rib mounted in the rim section and secured in the locking groove so that the rim section is secured on the mounting barrel; and

each of the protective caps is detachably secured in a respective one of the through holes of the wheel cover and has a first side defining a plurality of positioning recesses in one of which the locking section of the through hole of the wheel cover is secured, and a second side provided with a decorative protruding section extending outward from the fixing rim of the wheel cover.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional wheel cover for a vehicle of a large scale in accordance with the prior art;

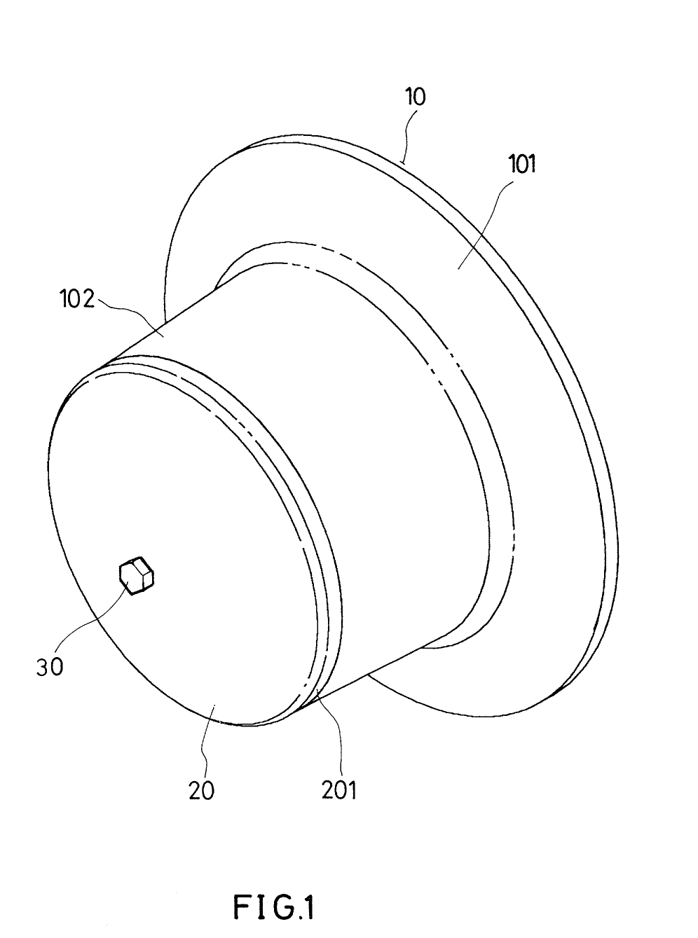

FIG. 2 is an exploded view of a wheel cover structure for a vehicle of a large scale in accordance with the present invention;

FIG. 3 is a partially enlarged view of the wheel cover structure as shown in FIG. 2;

FIG. 4 is a side plan cross-sectional assembly view of the wheel cover structure as shown in FIG. 2;

FIG. 5 is a partially cut-away front plan assembly view of the wheel cover structure as shown in FIG. 2; and

FIG. 6 is a perspective assembly view of the wheel cover structure as shown in FIG. 2.

### DETAILED DESCRIPTION OF THE INVENTION

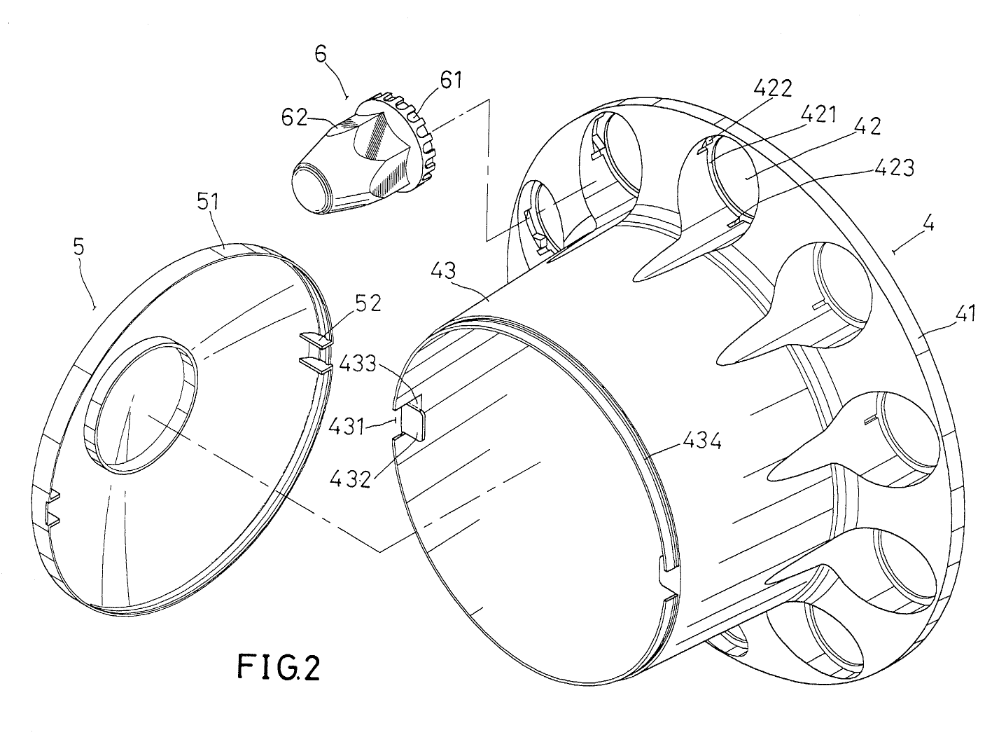

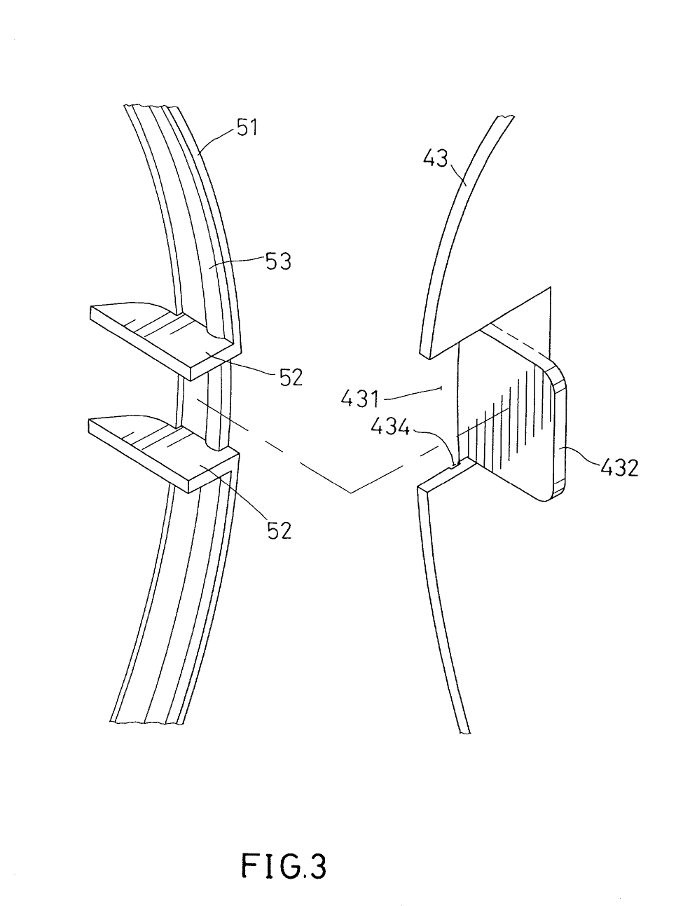

Referring to FIGS. 2-6, a wheel cover structure for a vehicle of a large scale in accordance with the present invention comprises a wheel cover 4, an outer cap 5, and a plurality of protective caps 6.

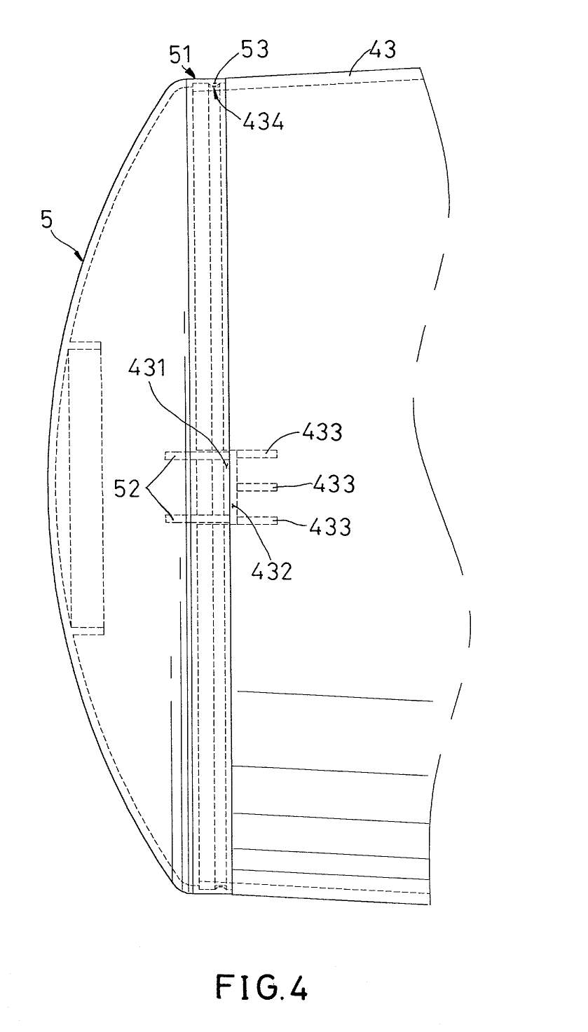

The wheel cover 4 includes an annular fixing rim 41, and a hollow mounting barrel 43. The annular fixing rim 41 defines a plurality of through holes 42 each provided with an annular flange 421, an elastic locking section 422 located adjacent to the annular flange 421, and a plurality of vent slots 423 located adjacent to the annular flange 421. The hollow mounting barrel 43 has a first side mounted on and extending outward from the central portion of the fixing rim 41, and a second side defining two opposite cavities 431 each provided with a resting plate 432 and a plurality of reinforcing ribs 433 (see FIG. 4) located beside the resting plate 432. An annular locking groove 434 is defined in the second side of the mounting barrel 43 and is located beside the cavities 431.

The outer cap 5 is removably secured on the mounting barrel 43 of the wheel cover 4 and includes a rim section 51 mounted on the second side of the mounting barrel 43; two opposite snap sections 52 each mounted in the rim section 51, each secured in the cavity 431, and each rested on the resting plate 433; and an annular locking rib 53 mounted in the rim section 51 and secured in the locking groove 434 so that the rim section 51 is secured on the mounting barrel 43.

Each of the protective caps 6 is detachably secured in a respective one of the through holes 42 of the wheel cover 4 and has a first side defining a plurality of positioning recesses 61 in one of which the locking section 422 of the through hole 42 of the wheel cover 4 is secured, and a second side provided with a hexagonal decorative protruding section 62 which protrudes outward from the fixing rim 41 of the wheel cover 4.

In assembly, the fixing rim 41 of the wheel cover 4 is pressed on the central wheel frame of the large scaled vehicle whereby the central protrusion of the wheel frame the vehicle is received in the mounting barrel 43.

The outer cap 5 is then mounted on the second side of the mounting barrel 43 whereby the locking rib 53 is secured in the locking groove 434 while each of the two opposite snap sections 52 is snapped into the cavity 431 and is rested on the resting plate 432 so that the outer cap 5 is secured on the mounting barrel 43 of the wheel cover 4 as shown in FIG. 4.

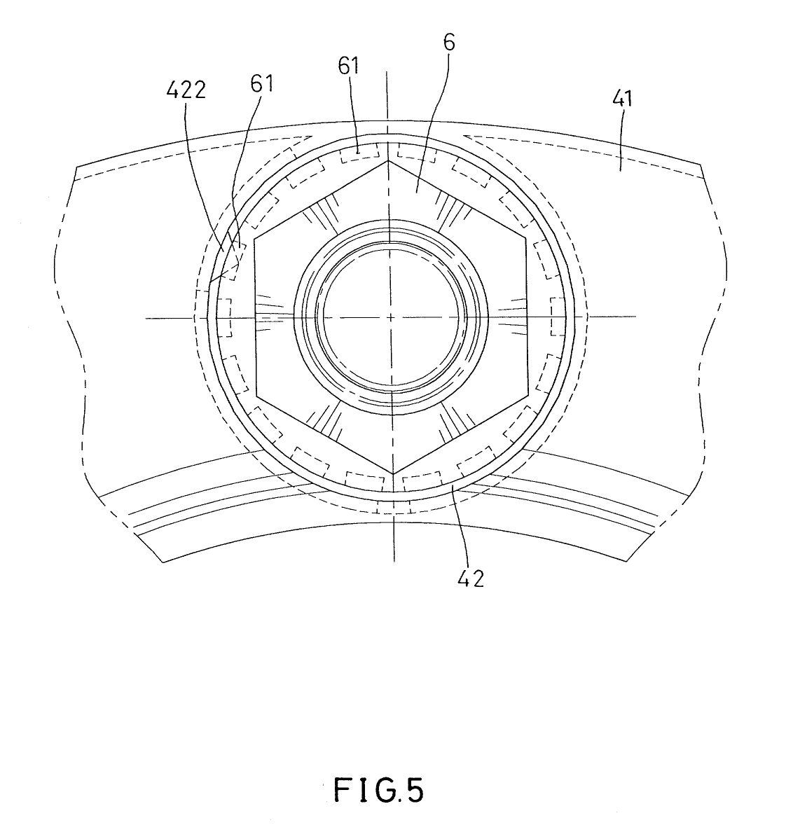

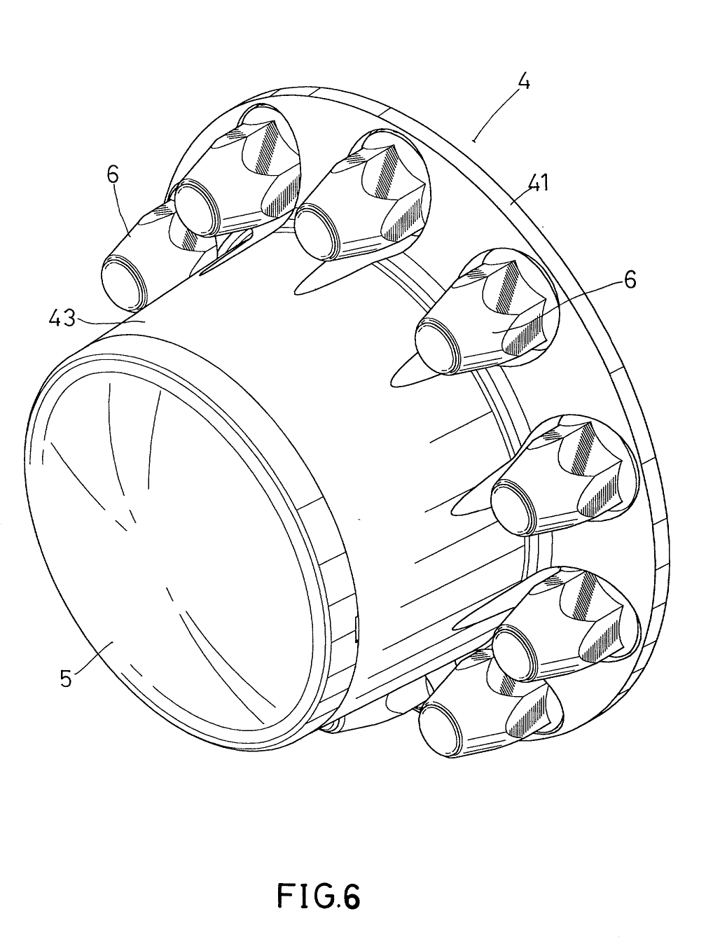

Each of the protective caps 6 is then inserted into the respective through hole 42 of the wheel cover 4 with the elastic locking section 422 of the through hole 42 being secured in one of the positioning recesses 61 as shown in FIG. 5 so that each of the protective caps 6 is secured in the respective through hole 42 of the wheel cover 4 and is prevented from being detached from the through hole 42, thereby accomplishing the assembly of the wheel cover structure as shown in FIG. 6. The vent holes 423 of the wheel cover 4 and the positioning recesses 61 of the protective cap 6 can be used to transfer the heat generated by the vehicle outward to the ambient environment.

A screwdriver can be inserted into the cavity 431 of the mounting barrel 43 and rested on the resting plate 432 to exert a force on the rim section 51 of the outer cap 5 so as to detach the outer cap 5 from the mounting barrel 43 of the wheel cover 4, thereby exposing the mounting barrel 43 of the wheel cover 4 for inspection or maintenance.

Accordingly, the wheel cover structure of the present invention has the following advantages.

1. The outer cap 5 is detached from the mounting barrel 43 of the wheel cover 4 by inserting a screwdriver into the cavity 431 of the mounting barrel 43 to exert a force on the rim section 51 of the outer cap 5 so that the outer cap 5 can be easily and quickly mounted on and detached from the mounting barrel 43 of the wheel cover 4, thereby facilitating assembling and dismantling the outer cap 5.

2. The reinforcing ribs 433 are used to strengthen the strength of the resting plate 432 whereby the snap section 52 is stably rested on the resting plate 432 so that the outer cap 5 can be stably mounted on the mounting barrel 43 of the wheel cover 4.

3. The outer cap 5 is easily molded by a punching process so that the outer cap 5 can be easily installed, thereby increasing the use efficiency of the wheel cover structure.

4. The vent holes 423 of the wheel cover 4 and the positioning recesses 61 of the protective cap 6 can be used to transfer the heat generated by the vehicle outward to the ambient environment while the decorative protruding section 62 can provide an ornamental effect, thereby providing a heat transfer effect and enhancing the aesthetic quality of the wheel cover structure.

It should be clear to those skilled in the art that further embodiments may be made without departing from the scope of the present invention.

What is claimed is:

1. A wheel cover structure for a vehicle of a large scale comprising: a wheel cover (4), an outer cap (5), and a plurality of protective caps (6), wherein,
said wheel cover (4) includes:
an annular fixing rim (41) defining a plurality of through holes (42) each provided with an annular flange (421), an elastic locking section (422) located adjacent to said annular flange (421), and a plurality of vent slots (423) located adjacent to said annular flange (421); and
a hollow mounting barrel (43) having a first side mounted on and extending outward from a central portion of said fixing rim (41) and a second side defining two opposite cavities (431) each provided with a resting plate (432) and a plurality of reinforcing ribs (433) located beside said resting plate (432), an annular locking groove (434) defined in said second side of said mounting barrel (43) and located beside said cavities (431);
said outer cap (5) is removably secured on said mounting barrel (43) of said wheel cover (4) and includes:
a rim section (51) mounted on said second side of said mounting barrel (43);
two opposite snap sections (52) each mounted in said rim section (51), each secured in said cavity (431), and each rested on said resting plate (433); and
an annular locking rib (53) mounted in said rim section (51) and secured in said locking groove (434) so that said rim section (51) is secured on said mounting barrel (43); and
each of said protective caps (6) is detachably secured in a respective one of said through holes (42) of said wheel cover (4) and has a first said defining a plurality of positioning recesses (61) in one of which said locking section (422) of said through hole (42) of said wheel cover (4) is secured, and a second side provided with a decorative protruding section (62) extending outward from said fixing rim (41) of said wheel cover (4).
